(19) United States
(12) Patent Application Publication
(10) Pub. No.: US 2007/0291307 A1
(43) Pub. Date: Dec. 20, 2007

(54) Image forming method and system to perform overlay

(75) Inventor: Man-chan Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/705,467

(22) Filed: Feb. 13, 2007

(30) Foreign Application Priority Data
Jun. 20, 2006 (KR) 2006-55412

(51) Int. Cl. H04N 1/00

(52) U.S. Cl. 358/1.18

(57) ABSTRACT

An image forming method and an image forming system to perform an overlay function. The method includes selecting a page that is to be overlaid from among pages in a document that is to be printed; generating a printing data, to which an overlay is applied, by applying the selected page as an overlaying page of the document that is to be printed; and printing the printing data. Therefore, a certain page is used to overlay, and is overlaid onto other pages, and thus, the overlay printing can be performed without performing several processes to overlay.

### CROSS-REFERENCE TO RELATED APPLICATIONS

This application claims the benefit of Korean Patent Application No. 10-2006-0055412, filed on Jun. 20, 2006, in the Korean Intellectual Property Office, the disclosure of which is incorporated herein in its entirety by reference.

### BACKGROUND OF THE INVENTION

1. Field of the Invention

The present general inventive concept relates to an overlay printing using a certain page, and more particularly, to an image forming method and an image forming system capable of performing an overlay printing in a simple way.

2. Description of the Related Art

Overlay is a function of printing a certain image or text attached to a document that is to be printed. For example, a logo of a company can be printed on a document that is to be printed, or a form such as a boundary can be printed.

Conventional overlay processes will be described as follows. An overlay document including an image, a text, or a boundary, which are to be overlaid, is generated and stored first. The overlay document is prepared, and when the location of a file in which the overlay document is to be stored is allocated, the overlay document is stored in that location. Next, an original document, to which the overlay will be applied, is loaded. After allocating the file location of the stored overlay document, the printing operation starts, and then, the overlay document is combined with the original document and printed together. As described above, in order to perform the conventional overlay printing, the process of generating the overlay document and the process of commanding the overlay printing after opening the original document should be performed independently, and thus, a large number of processes must be performed for executing the overlay printing. In addition, print settings of the overlay document and of the original document, to which the overlay is applied, do not coincide with each other, and thus, the size or location of the overlay document may be applied to an undesired portion of the original document. For example, if the overlay image is formed to a 600 [dpi] resolution and applied to the document of a 1200 [dpi] resolution, the resolution of the overlay image and the original document are different from each other, and thus, the size or location of the overlay image may be formed on an undesired portion of the original document.

### SUMMARY OF THE INVENTION

The present general inventive concept provides an image forming method of performing an overlay function that uses a certain page as an overlay page, and applies the overlay page to another page, and an image forming system that performs the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an image forming method of performing an overlay function, the method including: selecting a page that is to be overlaid from among pages in a document that is to be printed; generating printing data, to which an overlay is applied, by applying the selected page as an overlaying page of the document that is to be printed; and printing the printing data.

The foregoing and/or other aspects and utilities of the present general inventive concept are also achieved by providing an image forming system to perform an overlay function, the system including: a user interface to select a page that is to be overlaid from among pages of a document that is to be printed; an overlay application unit to apply the selected page as an overlaying page of the document that is to be printed, and to generate a printing data, to which the overlay is applied; and a printing unit to print the generated printing data.

The foregoing and/or other aspects and utilities of the present general inventive concept are also achieved by providing an image forming method of performing an overlay function, the method including selecting a page among plural pages in a document as an overlay of a document to be printed and applying the selected page as an overlaying page to the document that is to be printed.

The foregoing and/or other aspects and utilities of the present general inventive concept are also achieved by providing an overlay apparatus, including an overlay information storing unit to store a page selected as an overlaying page and a printing data generating unit to combine the stored overlay page with a document to be printed to generate printing data and to output the printing data.

The foregoing and/or other aspects and utilities of the present general inventive concept are also achieved by providing a recording medium having executable code stored thereon to perform a method of overlay, the method including selecting a page among plural pages in a document as an overlay of a document to be printed and applying the selected page as an overlaying page to the document that is to be printed.

The foregoing and/or other aspects and utilities of the present general inventive concept are also achieved by providing a computer readable recording medium having embodied thereon a computer program to execute a method including selecting a page that is to be overlaid from among pages in a document that is to be printed, generating printing data, to which an overlay is applied, by applying the selected page as an overlaying page of the document that is to be printed, and printing the printing data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flow chart illustrating an image forming method of performing an overlay function according to an embodiment of the present general inventive concept;

FIG. 2 is a view of a dialog window to select a page that is to be overlaid according to the embodiment of the present general inventive concept;

FIG. 3 is a flow chart illustrating operation 12 of the method illustrated in FIG. 1;

FIG. 4 is a view illustrating the image forming method of performing the overlay function, according to an embodiment of the present general inventive concept; and

FIG. 5 is a block diagram of an image forming system to perform an overlay function according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

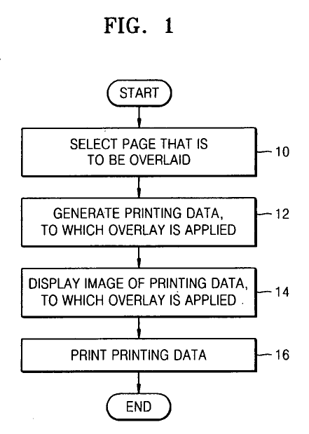

FIG. 1 is a flow chart illustrating an image forming method of performing an overlay function according to an embodiment of the present general inventive concept.

Referring to FIG. 1, a page that is to be overlaid is selected from among pages of a document that is to be printed (operation 10). A user selects the page that is to be overlaid from among the pages of the document that is to be printed. In particular, a first page of the document that is to be printed may be selected as the page to overlay.

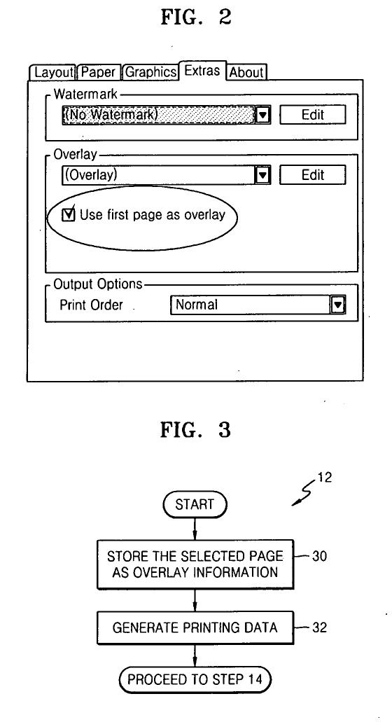

FIG. 2 illustrates an example of a dialog window to select the page that is to be overlaid. Referring to FIG. 2, the user can select the first page of the document that is to be printed as the page to overlay.

After performing operation 10, the selected page is applied as an overlay to the document that is to be printed, and printing data, to which the overlay is applied, is generated (operation 12).

The process of generating the printing data, to which the overlay is applied, can be performed in a host, or in an image forming apparatus. If the printing data, in which is overlay is applied, is generated in the host, the generated printing data is transmitted to the image forming apparatus.

In order to generate the printing data, to which the overlay is applied, in the image forming apparatus, information about the page that is to be overlaid should be transmitted to the image forming apparatus with the document that is to be printed. The image forming apparatus generates the printing data, to which the overlay is applied, using the information about the page that is to be overlaid and the document that is to be printed.

FIG. 3 is a flow chart illustrating operation 12 of the method illustrated in FIG. 1.

The selected page is stored as overlay information (operation 30). For example, if a first page is selected as the page to overlay, the overlay information corresponding to the first page is stored to overlay onto the document that is to be printed.

After operation 30, the stored overlay information is combined with the document that is to be printed to generate the printing data, to which the overlay is applied (operation 32). For example, if the first page is selected as the page to overlay, the overlay information is combined with contents from a second page of the document that is to be printed in operation 32 to generate the printing data of the combined document.

After operation 12, an image of the printing data, to which the overlay is applied, is displayed (operation 14). The image of the printing data, to which the overlay is applied, is displayed in order for the user to identify the document.

After operation 14, the printing data, to which the overlay is applied, is printed (operation 16). If the printing data is generated in the host, the generated printing data is transmitted to the image forming apparatus, and then the document is printed by a printing portion of the image forming apparatus using the transmitted printing data. Meanwhile, if the image forming apparatus receives the document that is to be printed, in which the overlay is not applied, the image forming apparatus generates the printing data, to which the overlay is applied, and outputs the printing data by the printing portion.

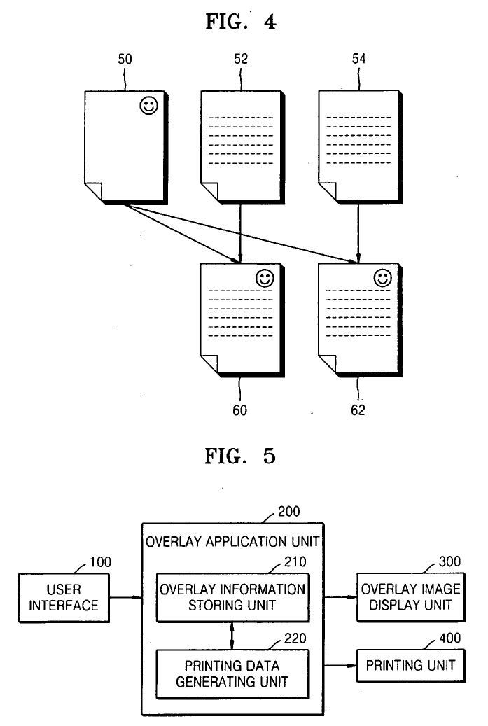

FIG. 4 is a view illustrating an image forming method of performing the overlaying function, according to an embodiment of the present general inventive concept. In the document that is to be printed including pages 50, 52, and 54, if the first page 50 is selected as the overlaying page, the selected page 50 is combined with the remaining pages 52 and 54 respectively, and thereby generating of the printing data 60 and 62, to which the overlay is applied, is performed. The printing data generated using this method is output by the printing portion of the image forming apparatus.

On the other hand, the method of the present general inventive concept can be performed through codes, instructions, or a program, which can be performed in a computer, and can be realized in a general-purpose digital computer, which operates the codes, instructions, or the program using a recording medium readable by the computer. The computer-readable recording medium includes a storage medium, such as a magnetic storing medium (for example, a ROM, a floppy disk, and a hard disk), an optical read-out medium (for example, a CD-ROM, DVD), and a carrier wave (for example, transmission through internet). In addition, the embodiments of the present general inventive concept can be realized as media including computer readable codes, and thus, a plurality of computer systems connected to each other by a network can separately process. The programs, codes, and code segments realizing the embodiments of the present general inventive concept can be construed easily by programmers in the present art.

An image forming system to perform the overlaying function according to an embodiment of the present general inventive concept will be described with reference to accompanying drawings in detail.

FIG. 5 is a block diagram of the image forming system to perform the overlaying function according to an embodiment of the present general inventive concept. The image forming system includes a user interface 100, an overlay application unit 200, an overlay image display unit 300, and a printing unit 400.

The page that is to be overlaid from among the pages of the document that is to be printed is selected through the user interface 100, and the user interface 100 outputs the selection result to the overlay application unit 200. The user selects the page used to overlay from among the pages of the document that is to be printed through the user interface 100. In particular, the user interface 100 may display a dialog window to select a first page of the document as the page to overlay. FIG. 2 illustrates an example of the dialog window displayed by the user interface 100. As illustrated in FIG. 2, the user can select the first page of the document as the page to overlay through the dialog window.

The overlay application unit 200 applies the selected page as the overlay to the document that is to be printed, generates the printing data, to which the overlay is applied, and outputs the generated printing data to an overlay image display unit 300 and a printing unit 400.

The overlay application unit 200 may be disposed in the host or in the image forming apparatus. When the overlay application unit 200 is disposed in the host, the printing data, to which the overlay is applied, is generated in the host, and then is transmitted to the image forming apparatus. When the overlay application unit 200 is disposed in the image forming apparatus, the host transfers the information about the page that is to be overlaid to the overlay application unit 200 in the image forming apparatus with the document that is to be printed.

The overlay application unit 200 includes an overlay information storing unit 210 and a printing data generating unit 220.

The overlay information storing unit 210 stores the page selected through the user interface 100 as overlay information. For example, if the first page is selected as the page to overlay, the overlay information storing unit 210 stores the overlay information corresponding to the first page as the information to overlay onto the document that is to be printed.

The printing data generating unit 220 combines the stored overlay information with the document that is to be printed to generate the printing data, to which the overlay is applied. For example, if the first page is selected as the page to overlay, the printing data generating unit 220 withdraws the overlay information stored in the overlay information storing unit 210 to combine the overlay information with the contents from a second page of the document and generate the printing data with respect to the document.

The overlay image display unit 300 displays an image of the printing data, to which the overlay is applied.

The printing unit 400 prints the printing data, to which the overlay is applied. If the printing data, to which the overlay is applied, is generated in the host, the generated printing data is transferred to the image forming apparatus, and the printing unit 400 outputs the transferred printing data.

According to the image forming method and system to perform the overlaying function of the present general inventive concept, a certain page is used as the page to overlay, and the selected page is overlaid onto other pages and the document is printed. Therefore, the overlay printing can be performed without performing several processes to apply the overlay. In addition, since the printing settings in generating the overlaying page and in applying the overlaying page are the same as each other, a misplacement of the overlaying image or text can be prevented in advance.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains. The method illustrated in FIG. 1 can be stored in the computer-recorded medium in a form of computer-readable codes to perform the method when the computer reads the computer-readable codes of the recording medium.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming method of performing an overlay function, the method comprising:
selecting a page that is to be overlaid from among pages in a document that is to be printed;
generating printing data, to which an overlay is applied, by applying the selected page as an overlaying page of the document that is to be printed; and
printing the printing data.

2. The method of claim 1, wherein the overlaying page is a first page of the document that is to be printed.

3. The method of claim 1, wherein the generating of the printing data, to which the overlay is applied, comprises:
storing the selected page as overlay information; and
combining the stored overlay information with the document that is to be printed in order to generate the printing data, to which the overlay is applied.

4. The method of claim 1, further comprising:
displaying an image of the printing data, to which the overlay is applied.

5. The method of claim 3, wherein the generating of the printing data, to which the overlay is applied, is performed in a host, and the printing data, to which the overlay is applied, is transferred to an image forming apparatus in order to be printed.

6. The method of claim 3, wherein the generating of the printing data, to which the overlay is applied, is performed in the image forming apparatus and printed.

7. A computer readable recording medium having embodied thereon a computer program to execute a method comprising:
selecting a page that is to be overlaid from among pages in a document that is to be printed;
generating printing data, to which an overlay is applied, by applying the selected page as an overlaying page of the document that is to be printed; and
printing the printing data.

8. An image forming system to perform an overlay function, the system comprising:
a user interface to select a page that is to be overlaid from among pages of a document that is to be printed;
an overlay application unit to apply the selected page as an overlaying page of the document that is to be printed, and to generate a printing data, to which the overlay is applied; and
a printing unit to print the generated printing data.

9. The system of claim 8, wherein the overlaying page is a first page in the document that is to be printed.

10. The system of claim 8, wherein the overlay application unit comprises:
an overlay information storing unit to store the selected page as overlay information; and
a printing data generating unit to combine the stored overlay information with the document that is to be printed in order to generate the printing data, to which the overlay is applied.

11. The system of claim 8, further comprising:
an image display unit to display an image of the printing data, to which the overlay is applied.

12. The system of claim 8, wherein the overlay application unit is formed in a host.

13. The system of claim 8, wherein the overlay application unit is formed in an image forming apparatus.

14. An image forming method of performing an overlay function, the method comprising:
selecting a page among plural pages in a document as an overlay of a document to be printed; and
applying the selected page as an overlaying page to the document that is to be printed.

15. The method of claim 14, further comprising:
printing the document with the applied overlaying page.

16. An overlay apparatus, comprising:
an overlay information storing unit to store a page selected as an overlaying page; and
a printing data generating unit to combine the stored overlay page with a document to be printed to generate printing data and to output the printing data.

17. The overlay apparatus of claim 16, further comprising:
an overlay image display unit to receive the output printing data ad to display an image of the printing data; and
a printing unit to print the printing data.

18. The overlay apparatus of claim 16, further comprising:
a user interface to select the overlaying page to be stored.

19. A recording medium having executable code stored thereon to perform a method of overlay, the method comprising:
selecting a page among plural pages in a document as an overlay of a document to be printed; and
applying the selected page as an overlaying page to the document that is to be printed.
